(19) United States
(12) Patent Application Publication
(10) Pub. No.: US 2018/0025879 A1
(43) Pub. Date: Jan. 25, 2018

(54) PROTECTION ELEMENT

(71) Applicants: Changwei Ho, New Taipei (TW); Suzhou Join Technology Innovation, Suzhou (CN)

(72) Inventors: Changwei Ho, New Taipei (TW); Haifeng Wang, Suzhou (CN)

(21) Appl. No.: 15/648,705

(22) Filed: Jul. 13, 2017

(30) Foreign Application Priority Data
Jul. 19, 2016 (TW) 105122669

(51) Int. Cl. H01H 85/12; H01H 85/08; H01H 85/143; H01H 85/06

(52) U.S. Cl. CPC H01H 85/12; H01H 85/06; H01H 85/08; H01H 85/143; H01H 2223/044

(57) ABSTRACT

Disclosed is a protection element having electrodes for electrically connecting an external circuit, and a fuse structure formed by stacking at least two metal layers of different melting points and installed between the at least two electrodes. The fusing temperature of the fuse structure can be adjusted by controlling the mass ratio of the two different metal layers, and such design not just offers more diversified product specifications to the protection element only, but also provides a broader range of selecting the metals to avoid metals that produce toxic substances, so as to help passing the RoHS standard of the protection element.

### FIELD OF INVENTION

The present invention relates to an overcurrent/overvoltage protection element, and more specifically relates to a protection element that controls a fusing temperature easily to facilitate the implementation of various different product specifications.

### BACKGROUND OF INVENTION

### 1. Description of the Related Art

As we all know, a general overcurrent/overvoltage protection element (hereinafter referred to as “protection element”) is primarily provided for protecting a circuit or an electric appliance to prevent a precision electronic device from being damaged by an instantaneous too-large current or voltage. When the instantaneous too-large current exceeds a predetermined current value, a fuse structure made of an alloy and installed in the protection element will be melted by high temperature of the heat produced by the instantaneous too-large current to form a short circuit, so that the too-large current will not flow into the circuit anymore, so as to protect the circuit and electric appliance.

A conventional protection element comprises two electrodes disposed on an insulating substrate, a fuse structure made of an alloy of a low melting point and coupled between the two electrodes, and a housing disposed on the insulating substrate and covering at least the fuse structure for preventing the metal of the fuse structure from being oxidized and the peripheral electronic components or circuit from being melted.

Most fuse structure of the conventional protection element is made of pure tin or any other low melting point alloy. Due to the low melting point (smaller than 245 degrees C.), the industrial standards cannot be met, and thus the conventional protection element fails to comply with practical applications. Some manufacturers use a high lead content tin alloy as the fuse structure of the protection element. Although such alloy has a relatively higher melting point (280˜300 degrees C.), it still fails to comply with the restriction of the use of certain hazardous substances in electrical and electronic equipment (RoHS) standard of the electrical and electronic devices.

In addition, the high melting point metal and the low melting point metal have different melting point ranges, and there are high melting point alloy and low melting point alloy. However, the fuse structure of the conventional protection element is generally made of alloys and thus it is not conducive to the diversity of product specifications. Therefore, it is an issue for related manufacturers and designers to provide a protection element and its related fuse structure with an easily controlled melting point to facilitate the implementation of various different product specifications and pass the RoHS standard.

### 2. Summary of the Invention

Therefore, it is a primary objective of the present invention to overcome the drawbacks of the conventional protection structure by providing a protection element capable of controlling the fusing temperature easily and facilitating the implementation of various product specifications.

To achieve the aforementioned and other objectives, the present invention provides a protection element comprising: at least two electrodes installed on an insulating substrate for electrically coupling an external circuit; a fuse structure electrically coupled between the at least two electrodes for fusing the electrodes at a predetermined temperature, a housing for at least covering the fuse structure; characterized in that the fuse structure is formed by stacking at least two metal layers of different melting points.

According to the aforementioned technical characteristics, the fuse structure of the protection element of the present invention is made of at least two metal layers of different melting points and formed between the at least two electrodes. The mass ratio of the different metal layers may be adjusted to control the fusing temperature of the fuse structure to achieve the effects of offering more diversified product specifications to the protection element, providing a broader range of selecting the metals to avoid the use of metals that produce toxic substances, and helping to pass the RoHS standard of the protection element.

According to the aforementioned technical characteristics, the fuse structure has a high melting point metal layer and a low melting point metal layer installed sequentially from bottom to top.

According to the aforementioned technical characteristics, the fuse structure has a low melting point metal layer and a high melting point metal layer installed sequentially from bottom to top.

According to the aforementioned technical characteristics, the fuse structure has a high melting point metal layer, a low melting point metal layer and a high melting point metal layer installed sequentially from bottom to top.

According to the aforementioned technical characteristics, the fuse structure has a low melting point metal layer, a high melting point metal layer and a low melting point metal layer installed sequentially from bottom to top.

According to the aforementioned technical characteristics, the fuse structure has a high melting point metal layer, a high melting point metal layer and a low melting point metal layer installed sequentially from bottom to top.

According to the aforementioned technical characteristics, the fuse structure has a low melting point metal layer, a high melting point metal layer, a high melting point metal layer and a low melting point metal layer installed sequentially from bottom to top.

According to the aforementioned technical characteristics, the fuse structure has a high melting point metal layer, a low melting point metal layer, a high melting point metal layer and a high melting point metal layer installed sequentially from bottom to top.

According to the aforementioned technical characteristics, the fuse structure has a high melting point metal layer, a high melting point metal layer, a low melting point metal layer and a high melting point metal layer installed sequentially from bottom to top.

According to the aforementioned technical characteristics, the fuse structure has a high melting point metal layer, a high melting point metal layer, a high melting point metal layer and a low melting point metal layer installed sequentially from bottom to top.

According to the aforementioned technical characteristics, the fuse structure has a tin layer made of tin and a copper layer made of copper; the tin layer and the copper layer have a volume ratio of 30:1˜120:1; the copper layer has a thickness falling within a range of 0.1˜2 μm; the tin layer has a thickness falling within a range of 3˜240 μm.

According to the aforementioned technical characteristics, the fuse structure has a tin layer made of tin and a copper layer made of copper; the tin layer and the copper layer have a volume ratio of 60:1; the copper layer has a thickness of 1.5 μm; and the tin layer has a thickness of 90 μm.

According to the aforementioned technical characteristics, the fuse structure has a tin layer made of tin and a nickel layer made of nickel; the tin layer and the nickel layer have a volume ratio of 50:1˜160:1; the nickel layer has a thickness falling within a range of 0.1˜2 μm; and the tin layer has a thickness falling within a range of 5˜320 μm.

According to the aforementioned technical characteristics, the fuse structure has a tin layer made of tin and a nickel layer made of nickel; the tin layer and the nickel layer have a volume ratio of 90:1; the nickel layer has a thickness of 1 μm; and the tin layer has a thickness of 90 μm.

According to the aforementioned technical characteristics, the fuse structure has a tin layer made of tin and a silver layer made of silver; the tin layer and the silver layer have a volume ratio of 25:1˜110:1; the silver layer has a thickness falling within a range of 0.1˜2 μm; and the tin layer has a thickness falling within a range of 2.5˜220 μm.

According to the aforementioned technical characteristics, the fuse structure has a tin layer made of tin and a silver layer made of silver; the tin layer and the silver layer have a volume ratio of 50:1; the silver layer has a thickness of 1.5 μm; and the tin layer has a thickness of 75 μm.

According to the aforementioned technical characteristics, the fuse structure has a tin layer made of tin, a copper layer made of copper and a silver layer made of silver; the tin layer, the copper layer and the silver layer have a volume proportion of 60:1:1˜240:1:1; the copper layer plus the silver layer have a total thickness falling within a range of 0.2˜4 μm; and the tin layer has a thickness of 6˜480 μm.

According to the aforementioned technical characteristics, the fuse structure has a tin layer made of tin, a copper layer made of copper and a silver layer made of silver; the tin layer, the copper layer and the silver layer have a volume proportion of 120:1:1; the copper layer plus the silver layer have a total thickness of 1.5 μm; and the tin layer has a thickness of 90 μm.

According to the aforementioned technical characteristics, the fuse structure has a tin layer made of tin, a nickel layer made of nickel and a copper layer made of copper; the tin layer, the nickel layer and the copper layer have a volume proportion of 100:0.5:1˜320:0.5:1; the nickel layer plus the copper layer have a total thickness falling within a range of 0.15˜3 μm; and the tin layer has a thickness falling within a range of 10˜640 μm.

According to the aforementioned technical characteristics, the fuse structure has a tin layer made of tin, a nickel layer made of nickel and a copper layer made of copper; the tin layer, the nickel layer and the copper layer have a volume ratio of 200:0.5:1; the nickel layer plus the copper layer have a total thickness of 0.6 μm; and the tin layer has a thickness of 80 μm.

According to the aforementioned technical characteristics, the fuse structure has a tin layer made of tin, a silver layer made of silver and a nickel layer made of nickel; the tin layer, the silver layer and the nickel layer have a volume proportion of 50:1:0.5˜220:1:0.5; the silver layer plus the nickel layer have a total thickness falling within a range of 0.15˜3 μm; and the tin layer has a thickness falling within a range of 5˜440 μm.

According to the aforementioned technical characteristics, the fuse structure has a tin layer made of tin, a silver layer made of silver and a nickel layer made of nickel; the tin layer, the silver layer and the nickel layer have a volume proportion of 150:1:0.5; the silver layer plus the nickel layer have a total thickness of 0.6 μm; and the tin layer has a thickness of 80 μm.

According to the aforementioned technical characteristics, the fuse structure has a tin layer made of tin, a copper layer made of copper, a nickel layer made of nickel and a chromium layer made of chromium; the tin layer, the copper layer, the nickel layer and the chromium layer have a volume proportion of 80:1:0.5:0.125˜300:1:0.5:0.125; the copper layer plus the nickel layer plus the chromium layer have a total thickness falling within a range of 0.1625˜3.25 μm; and the tin layer has a thickness falling within a range of 8˜600 μm.

According to the aforementioned technical characteristics, the fuse structure has a tin layer made of tin, a copper layer made of copper, a nickel layer made of nickel and a chromium layer made of chromium; the tin layer, the copper layer, the nickel layer and the chromium layer have a volume proportion of 120:1:0.5:0.125; the copper layer plus the nickel layer plus the chromium layer have a total thickness of 0.6 μm; and the tin layer has a thickness of 92 μm.

Each low melting point metal layer has a melting point falling within a range of 60˜350 degrees C., each high melting point metal layer has a melting point falling within a range of 600˜1900 degrees C.

Each low melting point metal layer is made of a metal selected from the group consisting of tin, indium and bismuth; each high melting point metal layer is made of a metal selected from the group consisting of aluminum, silver, copper, nickel, chromium, iron, gold, platinum, palladium and titanium.

Each metal layer is constructed and formed by a method selected from the group of sputtering, evaporation, chemical plating, ion plating, electroplating and vapor deposition.

Each metal layer is constructed to be substantially in a rectangular profile.

Each metal layer is constructed to be substantially in an H-shaped profile.

Each metal layer is constructed to be substantially in a serpentine profile.

The protection element of the present invention uses the structural design of the fuse structure formed by stacking at least two metal layers of different melting points, so that the fusing temperature of the fuse structure can be adjusted by controlling the mass ratio of the different metal layers, and such design not just provides more diversified product specifications to the protection element only, but also provides a broader range of selecting the metals to avoid metals that produce toxin, so as to help passing the RoHS standard of the protection element.

### BRIEF DESCRIPTION OF THE DRAWINGS

FIG. 1 is a perspective view of a protection element of a first preferred embodiment of the present invention;

FIG. 2 is a cross-sectional view of a protection element of the first preferred embodiment of the present invention;

FIG. 3 is an exploded view of a protection element of the first preferred embodiment of the present invention;

FIG. 4 is a cross-sectional view of a protection element of a second preferred embodiment of the present invention;

FIG. 5 is a cross-sectional view of a protection element of a third preferred embodiment of the present invention;

FIG. 6 is a perspective view of a fuse structure of a protection element in accordance with a fourth preferred embodiment of the present invention; and

FIG. 7 is a perspective view of a fuse structure of a protection element in accordance with a fifth preferred embodiment of the present invention.

### BRIEF DESCRIPTION OF THE DRAWINGS

### Description of the Preferred Embodiments

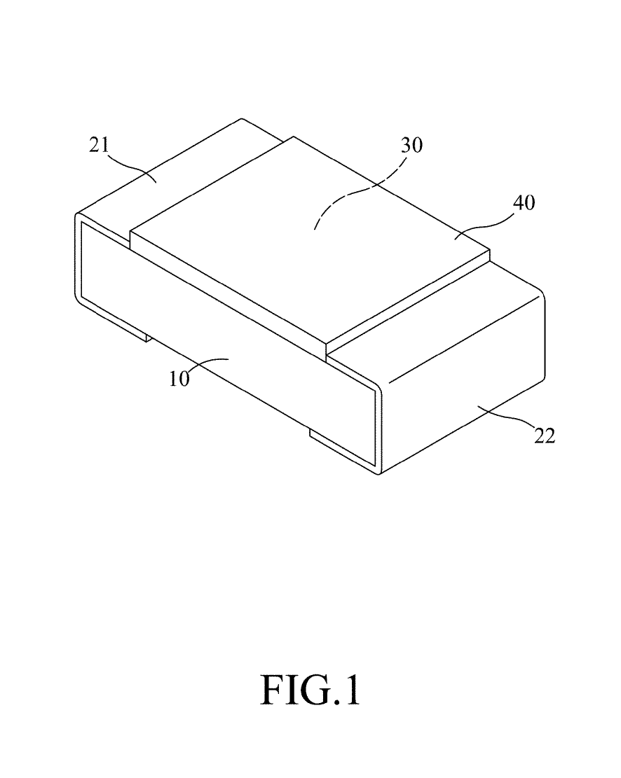

The present invention is further elaborated by preferred embodiments as follows: with reference to FIGS. 1 to 3 for a protection element of the present invention, the protection element is capable of controlling the fusing temperature easily to facilitate the implementation of more diversified product specifications, the protection element comprises at least two electrodes 21, 22 installed on an insulating substrate 10 and provided for electrically coupling an external circuit, a fuse structure 30 electrically coupled between the at least two electrodes 21, 22 and provided for fusing at a predetermined temperature, and a housing 40 for at least covering the fuse structure 30.

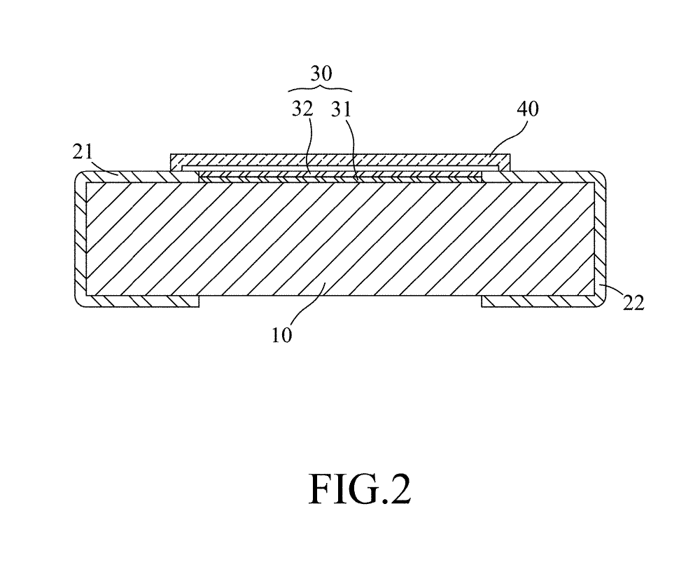

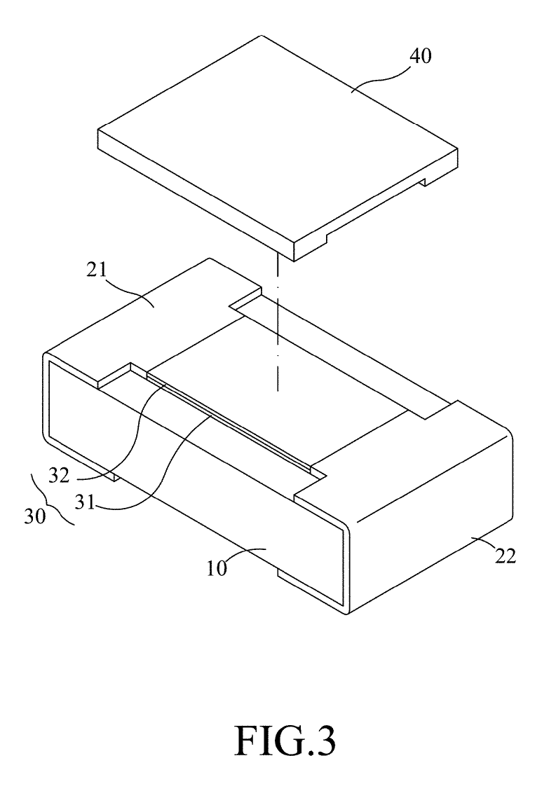

The present invention is characterized in that the fuse structure 30 is formed by stacking at least two metal layers of different melting points. In the first preferred embodiment as shown in FIGS. 2 and 3, the fuse structure 30 comprises a high melting point metal layer 31 and a low melting point metal layer 32 installed sequentially from bottom to top, or a low melting point metal layer and a high melting point metal layer installed sequentially from bottom to top.

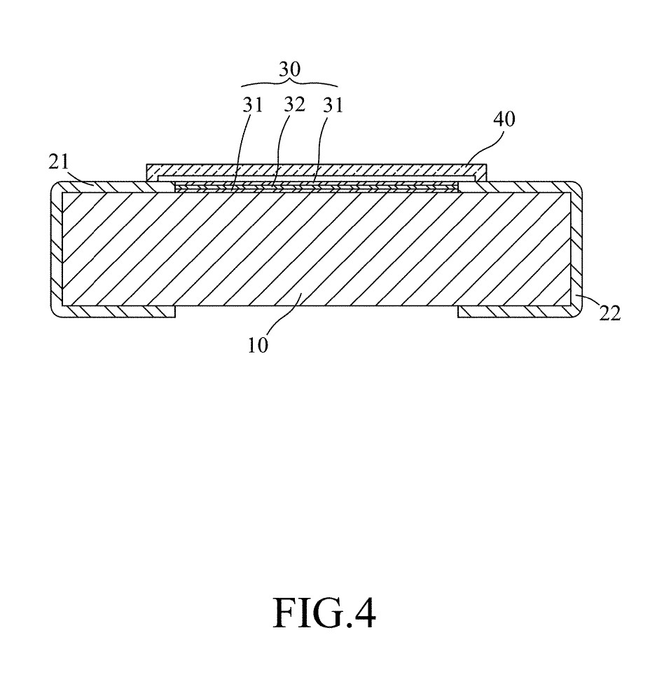

With reference to FIG. 4 for a fuse structure in accordance with the second preferred embodiment of the present invention, the fuse structure 30 comprises a high melting point metal layer 31, a low melting point metal layer 32 and a high melting point metal layer 31 installed sequentially from bottom to top, or a low melting point metal layer, a high melting point metal layer and a low melting point metal layer installed sequentially from bottom to top, or a high melting point metal layer, a high melting point metal layer and a low melting point metal layer installed sequentially from bottom to top.

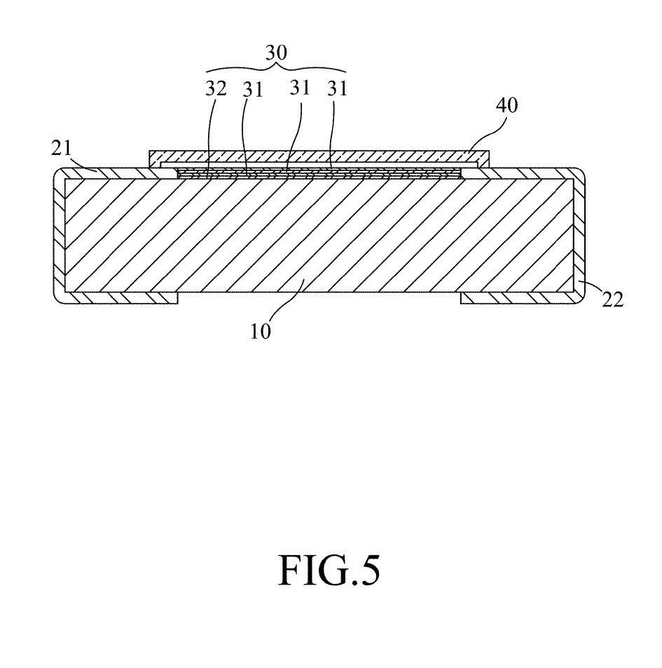

With reference to FIG. 5 for the fuse structure 30, the fuse structure comprises a low melting point metal layer 32, a high melting point metal layer 31, a high melting point metal layer 31 and a high melting point metal layer 31 installed sequentially from bottom to top, or a high melting point metal layer, a low melting point metal layer, a high melting point metal layer and a high melting point metal layer installed sequentially from bottom to top, or a high melting point metal layer, a high melting point metal layer, a low melting point metal layer and a high melting point metal layer installed sequentially from bottom to top, or a high melting point metal layer, a high melting point metal layer, a high melting point metal layer and a low melting point metal layer installed sequentially from bottom to top.

Each low melting point metal layer has a melting point falling within a range of 60˜350 degrees C., each high melting point metal layer has a melting point falling within a range of 600˜1900 degrees C., and each low melting point metal layer is a metal such as tin, indium or bismuth; each high melting point metal layer is a metal such as aluminum, silver, copper, nickel, chromium, iron, gold, platinum, palladium or titanium.

With reference to FIGS. 2 and 3 for a protection element in accordance with the first preferred embodiment of the present invention, the protection element has a fuse structure 30 made of at least two metal layers of different melting points and formed between at least two electrodes 21, 22 (such as a high melting point metal layer 31 and a low melting point metal layer 32 (as shown in the figures), wherein all metal layers (including the high melting point metal layer 31 and the low melting point metal layer 32) of the fuse structure 30 is normally electrically conducted with the electrodes of the protection element, so that the protection element can be applied to a circuit that requires overcurrent or overvoltage protection.

If a surge current exceeds a predetermined current value, the metal layer with a relatively lower melting point (or the low melting point metal layer 32) in the fuse structure 30 will be melted first. In addition, the impedance of the current of the fuse structure 30 is increased instantaneously, the other metal layer with a relatively higher melting point (or the high melting point metal layer 31) will be melted by high temperature to produce a power disconnection effect to protect the circuit from being damaged. In particular, the fusing temperature of the fuse structure can be adjusted by controlling the mass ratio of the different metal layers, so as to achieve the effects of offering more diversified product specifications to the protection element, providing a broader range of selecting the metals to avoid the use of metals that produce toxic substances, and helping to pass the RoHS standard of the protection element.

In a first implementation mode of the present invention, the fuse structure comprises a tin layer made of tin and a copper layer made of copper, wherein the tin layer and the copper layer have a volume ratio of 30:1˜120:1; the copper layer has a thickness falling within a range of 0.1˜2 μm; and the tin layer has a thickness falling within a range of 3˜240 μm. In this implementation mode; the tin layer and the copper layer preferably have a volume ratio of 60:1; the copper layer preferably has a thickness of 1.5 μm; and the tin layer preferably has a thickness of 90 μm.

In a second implementation mode of the present invention, the fuse structure comprises a tin layer made of tin and a nickel layer made of nickel; wherein the tin layer and the nickel layer have a volume ratio of 50:1˜160:1; the nickel layer has a thickness falling within a range of 0.1˜2 μm; and the tin layer has a thickness falling within a range of 5˜320 μm. In this implementation mode, the tin layer and the nickel layer preferably have a volume ratio of 90:1; the nickel layer preferably has a thickness of 1 μm; and the tin layer preferably has a thickness of 90 μm.

In a third implementation mode of the present invention, the fuse structure comprises a tin layer made of tin and a silver layer made of silver; wherein the tin layer and the silver layer have a volume ratio of 25:1˜110:1; the silver layer has a thickness falling within a range of 0.1˜2 μm; the tin layer has a thickness falling within a range of 2.5˜220 μm. In this implementation mode, the tin layer and the silver layer preferably have a volume ratio of 50:1; the silver layer preferably has a thickness of 1.5 μm; and the tin layer preferably has a thickness of 75 μm.

In a fourth implementation mode of the present invention, the fuse structure comprises a tin layer made of tin, a copper layer made of copper and a silver layer made of silver; wherein the tin layer, the copper layer and the silver layer have a volume proportion of 60:1:1˜240:1:1; the copper layer plus the silver layer have a total thickness falling within a range of 0.2˜4 μm; and the tin layer has a thickness falling within a range of 6˜480 μm. In this implementation mode, the tin layer, the copper layer and the silver layer preferably have a volume proportion of 120:1:1; the copper layer plus the silver layer preferably have a total thickness of 1.5 μm; and the tin layer preferably has a thickness of 90 μm.

In a fifth implementation mode of the present invention, the fuse structure comprises a tin layer made of tin, a nickel layer made of nickel and a copper layer made of copper; wherein the tin layer, the nickel layer and the copper layer have a volume proportion of 100:0.5:1˜320:0.5:1; the nickel layer plus the copper layer have a total thickness falling within a range of 0.15˜3 μm; the tin layer has a thickness falling within a range of 10˜640 μm. In this implementation mode, the tin layer, the nickel layer and the copper layer preferably have a volume proportion of 200:0.5:1; the nickel layer plus the copper layer preferably have a total thickness of 0.6 μm; and the tin layer preferably has a thickness of 80 μm.

In a sixth implementation mode of the present invention, the fuse structure comprises a tin layer made of tin, a silver layer made of silver and a nickel layer made of nickel; wherein the tin layer, the silver layer and the nickel layer have a volume proportion of 50:1:0.5˜220:1:0.5; the silver layer plus the nickel layer have a total thickness falling within a range of 0.15˜3 μm; and the tin layer has a thickness falling within a range of 5˜440 μm. In this implementation mode, the tin layer, the silver layer and the nickel layer preferably have a volume proportion of 150:1:0.5; the silver layer plus the nickel layer preferably have a total thickness of 0.6 μm; and the tin layer preferably has a thickness of 80 μm.

In a seventh implementation mode of the present invention, the fuse structure comprises a tin layer made of tin, a copper layer made of copper, a nickel layer made of nickel and a chromium layer made of chromium; wherein the tin layer, the copper layer, the nickel layer and the chromium layer have a volume proportion of 80:1:0.5:0.125˜300:1:0.5:0.125; the copper layer plus the nickel layer plus the chromium layer have a total thickness falling within a range of 0.1625˜3.25 μm; and the tin layer has a thickness falling within a range of 8˜600 μm. In this implementation mode, the tin layer, the copper layer, the nickel layer and the chromium layer preferably have a volume proportion of 120:1:0.5:0.125; the copper layer plus the nickel layer plus the chromium layer preferably have a total thickness of 0.6 μm; and the tin layer preferably has a thickness of 92 μm.

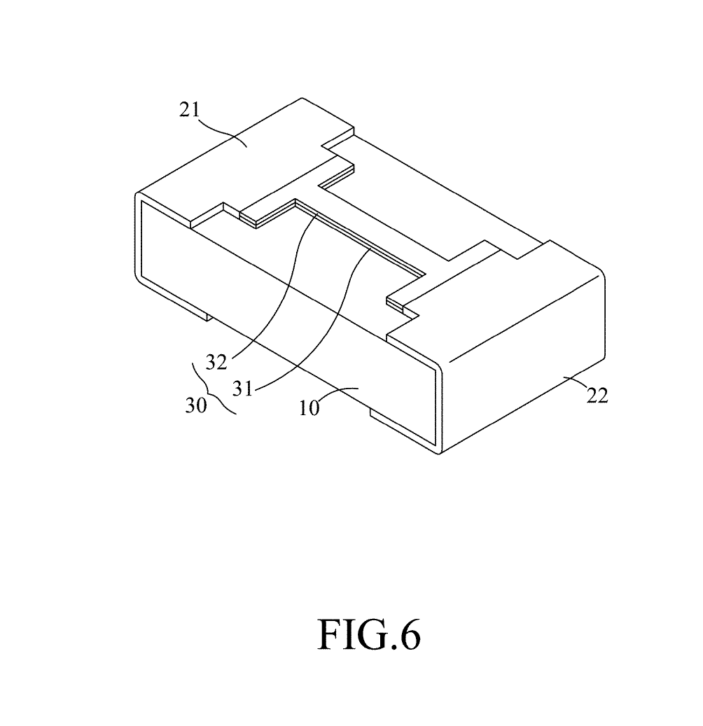

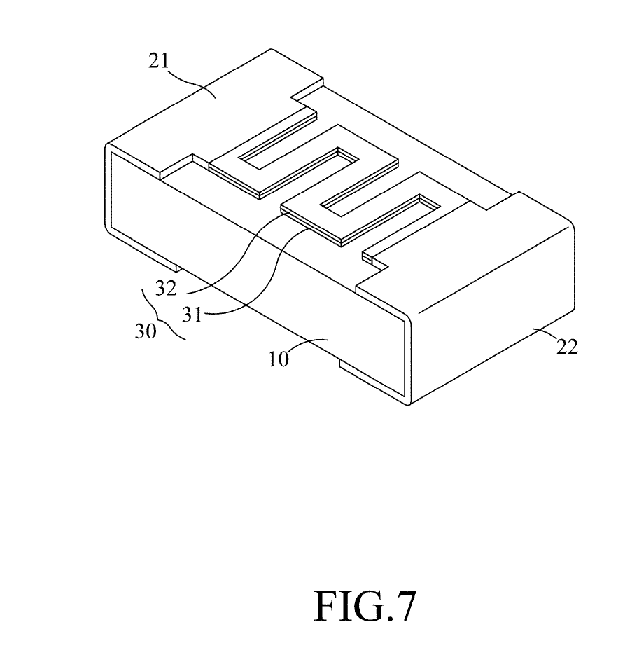

In the protection element of different embodiments of the present invention, each metal layer may be constructed and formed by sputtering, evaporation, chemical plating, ion plating, electroplating or vapor deposition. It is noteworthy that each metal layer may be formed by electroplating except the metal layer in contact with the insulating substrate. Each metal layer (such as the high melting point metal layer 31 or the low melting point metal layer 32) may be formed into a rectangular profile as shown in FIG. 3, so that the whole fuse structure 30 may achieve a one-time fusing effect with a smaller resistance value. Of course, each metal layer (such as the high melting point metal layer 31 or the low melting point metal layer 32) may be formed into an H-shaped profile as shown in FIG. 6, so that the fusing position of the fuse structure 30 can be controlled. Further, each metal layer (such as the high melting point metal layer 31 or the low melting point metal layer 32) may be formed into a serpentine profile as shown in FIG. 7, so that the fuse structure 30 may provide a one-time fusing effect with a larger resistance value.

Specifically, the protection element of the present invention uses the structural design of the fuse structure formed by stacking at least two metal layers of different melting points, so that the fusing temperature of the fuse structure can be adjusted by controlling the mass ratio of the different metal layers, and such design not just offers more diversified product specifications to the protection element only, but also provides a broader range of selecting the metals to avoid metals that produce toxic substances, so as to help passing the RoHS standard of the protection element.

While the invention has been described by means of specific embodiments, numerous modifications and variations could be made thereto by those skilled in the art without departing from the scope and spirit of the invention set forth in the claims.

What is claimed is:

1. A protection element, comprising: at least two electrodes installed on an insulating substrate for electrically coupling an external circuit; a fuse structure electrically coupled between the at least two electrodes for fusing the electrodes at a predetermined temperature, and a housing for at least covering the fuse structure; characterized in that the fuse structure is formed by stacking at least two metal layers of different melting points.

2. The protection element of claim 1, wherein the fuse structure comprises a high melting point metal layer and a low melting point metal layer installed sequentially from bottom to top.

3. The protection element of claim 1, wherein the fuse structure comprises a low melting point metal layer and a high melting point metal layer installed sequentially from bottom to top.

4. The protection element of claim 1, wherein the fuse structure comprises a high melting point metal layer, a low melting point metal layer and a high melting point metal layer installed sequentially from bottom to top.

5. The protection element of claim 1, wherein the fuse structure comprises a low melting point metal layer, a high melting point metal layer and a low melting point metal layer installed sequentially from bottom to top.

6. The protection element of claim 1, wherein the fuse structure comprises a high melting point metal layer, a high melting point metal layer and a low melting point metal layer installed sequentially from bottom to top.

7. The protection element of claim 1, wherein the fuse structure comprises a low melting point metal layer, a high melting point metal layer, a high melting point metal layer and a high melting point metal layer installed sequentially from bottom to top.

8. The protection element of claim 1, wherein the fuse structure comprises a high melting point metal layer, a low melting point metal layer, a high melting point metal layer and a high melting point metal layer installed sequentially from bottom to top.

9. The protection element of claim 1, wherein the fuse structure comprises a high melting point metal layer, a high melting point metal layer, a low melting point metal layer and a high melting point metal layer installed sequentially from bottom to top.

10. The protection element of claim 1, wherein the fuse structure comprises a high melting point metal layer, a high melting point metal layer, a high melting point metal layer and a low melting point metal layer installed sequentially from bottom to top.

11. The protection element of claim 1, wherein the fuse structure has a tin layer made of tin and a copper layer made of copper; the tin layer and the copper layer have a volume ratio of 30:1˜120:1; the copper layer has a thickness falling within a range of 0.1˜2 μm; the tin layer has a thickness falling within a range of 3˜240 μm.

12. The protection element of claim 1, wherein the fuse structure has a tin layer made of tin and a copper layer made of copper; the tin layer and the copper layer have a volume ratio of 60:1; the copper layer has a thickness of 1.5 μm; and the tin layer has a thickness of 90 μm.

13. The protection element of claim 1, wherein the fuse structure has a tin layer made of tin and a nickel layer made of nickel; the tin layer and the nickel layer have a volume ratio of 50:1˜160:1; the nickel layer has a thickness falling within a range of 0.1˜2 μm; and the tin layer has a thickness falling within a range of 5˜320 μm.

14. The protection element of claim 1, wherein the fuse structure has a tin layer made of tin and a nickel layer made of nickel; the tin layer and the nickel layer have a volume ratio of 90:1; the nickel layer has a thickness of 1 μm; and the tin layer has a thickness of 90 μm.

15. The protection element of claim 1, wherein the fuse structure has a tin layer made of tin and a silver layer made of silver; the tin layer and the silver layer have a volume ratio of 25:1˜110:1; the silver layer has a thickness falling within a range of 0.1˜2 μm; and the tin layer has a thickness falling within a range of 2.5˜220 μm.

16. The protection element of claim 1, wherein the fuse structure has a tin layer made of tin and a silver layer made of silver; the tin layer and the silver layer have a volume ratio of 50:1; the silver layer has a thickness of 1.5 μm; and the tin layer has a thickness of 75 μm.

17. The protection element of claim 1, wherein the fuse structure has a tin layer made of tin, a copper layer made of copper and a silver layer made of silver; the tin layer, the copper layer and the silver layer have a volume proportion of 60:1:1˜240:1:1; the copper layer plus the silver layer have a total thickness falling within a range of 0.2˜4 μm; and the tin layer has a thickness of 6˜480 μm.

18. The protection element of claim 1, wherein the fuse structure has a tin layer made of tin, a copper layer made of copper and a silver layer made of silver; the tin layer, the copper layer and the silver layer have a volume proportion of 120:1:1; the copper layer plus the silver layer have a total thickness of 1.5 μm; and the tin layer has a thickness of 90 μm.

19. The protection element of claim 1, wherein the fuse structure has a tin layer made of tin, a nickel layer made of nickel and a copper layer made of copper; the tin layer, the nickel layer and the copper layer have a volume proportion of 100:0.5:1˜320:0.5:1; the nickel layer plus the copper layer have a total thickness falling within a range of 0.15˜3 μm; and the tin layer has a thickness falling within a range of 10˜640 μm.

20. The protection element of claim 1, wherein the fuse structure has a tin layer made of tin, a nickel layer made of nickel and a copper layer made of copper; the tin layer, the nickel layer and the copper layer have a volume proportion of 200:0.5:1; the nickel layer plus the copper layer have a total thickness of 0.6 μm; and the tin layer has a thickness of 80 μm.

21. The protection element of claim 1, wherein the fuse structure has a tin layer made of tin, a silver layer made of silver and a nickel layer made of nickel; the tin layer, the silver layer and the nickel layer have a volume proportion of 50:1:0.5˜220:1:0.5; the silver layer plus the nickel layer have a total thickness falling within a range of 0.15˜3 μm; and the tin layer has a thickness falling within a range of 5˜440 μm.

22. The protection element of claim 1, wherein the fuse structure has a tin layer made of tin, a silver layer made of silver and a nickel layer made of nickel; the tin layer, the silver layer and the nickel layer have a volume proportion of 150:1:0.5; the silver layer plus the nickel layer have a total thickness of 0.6 μm; and the tin layer has a thickness of 80 μm.

23. The protection element of claim 1, wherein the fuse structure has a tin layer made of tin, a copper layer made of copper, a nickel layer made of nickel and a chromium layer made of chromium; the tin layer, the copper layer, the nickel layer and the chromium layer have a volume proportion of 80:1:0.5:0.125˜300:1:0.5:0.125; the copper layer plus the nickel layer plus the chromium layer have a total thickness falling within a range of 0.1625˜3.25 μm; and the tin layer has a thickness falling within a range of 8˜600 μm.

24. The protection element of claim 1, wherein the fuse structure has a tin layer made of tin, a copper layer made of copper, a nickel layer made of nickel and a chromium layer made of chromium; the tin layer, the copper layer, the nickel layer and the chromium layer have a volume proportion of 120:1:0.5:0.125; the copper layer plus the nickel layer plus the chromium layer have a total thickness of 0.6 μm; and the tin layer has a thickness of 92 μm.

25. The protection element of claim 1, wherein each metal layer is constructed and formed by a method selected from the group of sputtering, evaporation, chemical plating, ion plating, electroplating and vapor deposition.

26. The protection element of claim 1, wherein each metal layer is constructed to be substantially in a rectangular profile.

27. The protection element of claim 1, wherein each metal layer is constructed to be substantially in an H-shaped profile.

28. The protection element of claim 1, wherein each metal layer is constructed to be substantially in a serpentine profile.

29. The protection element of claim 2, wherein each low melting point metal layer has a melting point falling within a range of 60˜350 degrees C., each high melting point metal layer has a melting point falling within a range of 600˜1900 degrees C.

30. The protection element of claim 2, wherein each low melting point metal layer is made of a metal selected from the group consisting of tin, indium and bismuth; each high melting point metal layer is made of a metal selected from the group consisting of aluminum, silver, copper, nickel, chromium, iron, gold, platinum, palladium and titanium.
